(19) United States
(12) Patent Application Publication
(10) Pub. No.: US 2026/0184289 A1
(43) Pub. Date: Jul. 2, 2026

(54) DETAIL CLEANING DEVICE

(71) Applicant: Unger Marketing International, LLC, Bridgeport, CT (US)

(72) Inventors: James M. Buckley, New Hartford, CT (US); Audrey McMahon, Kokomo, IN (US); Joseph K. Patterson, Monroe, CT (US); William Harrington, Newtown, CT (US); Stephen P. Huda, Shelton, CT (US); Brandon M. Temple, Stamford, CT (US)

(21) Appl. No.: 19/437,787

(22) Filed: Dec. 31, 2025

Related U.S. Application Data
(60) Provisional application No. 63/741,198, filed on Jan. 2, 2025.

(51) Int. Cl. B60S 3/04; A46B 5/00; A46B 5/02; A46B 11/00; A46B 11/06

(52) U.S. Cl. CPC B60S 3/042; A46B 5/0095; A46B 5/02; A46B 11/0082; A46B 11/063; B60S 3/044; A46B 2200/3046

(57) ABSTRACT

A detail cleaning device is provided. The detail cleaning device having a handle assembly. The handle assembly having a handle body and at least one gripping feature. A detail portion is provided having an elliptical shape. A middle section is provided having a substantially cylindrical shape with a progressively decreasing diameter. The middle section being disposed between the handle assembly and the detail portion.

### CROSS-REFERENCE TO RELATED APPLICATIONS

This patent application claims priority to U.S. Provisional Patent Application No. 63/741,198, filed Jan. 2, 2025, the contents of which are hereby incorporated by reference in its entirety.

### BACKGROUND

The subject matter disclosed herein relates to devices such as detail cleaning tools for wheels, and more particularly a detail cleaning tool that is flexible and may be water-fed.

Dirt and other debris frequently accumulate on rims and other surfaces of vehicle wheels. Due to the type of dirt and debris that accumulate on wheels (e.g., rims, tires), it can be difficult to remove. Various methods and tools may be used to clean wheels. A common method is using a cloth or rag. This method is disadvantageous as it requires greater force to be applied by the user to scrub away the dirt and other debris. Brushes or sponges are sometimes used. These methods too are disadvantageous as a sponge still requires greater force to be applied by the user and conventional brushes are inflexible. As a result the conventional brushes do not clean the nooks and crevices of the wheels. Furthermore, users become fatigued quickly by having to apply greater force when using the cleaning tool.

Additionally, with all of the previously mentioned methods, the cleaning cloth gets dirty and contaminated as it is used and the user must consistently use their hand to dip the cleaning cloth into a bucket or other external source of water to rinse off the dirt and replenish the tool with water/cleaning solution. As such, the use of a cleaning cloth for cleaning vehicle wheels is inefficient.

Accordingly, it is desirable to provide a device that provides sufficient rigidity to scrub away of the dirt and debris having features described herein.

### BRIEF DESCRIPTION

According to an embodiment, a detail cleaning device is provided. According to an embodiment, the detail cleaning device includes a handle assembly including a handle body and a detail portion coupled to the handle assembly, the handle assembly and the detail portion defining a longitudinal axis. The detail portion includes a plurality of ribs spaced from each other along the longitudinal axis between a first end of the detail portion in proximity to the handle assembly and a second end opposite from the first end, the plurality of ribs defining a frustoconical shape along the longitudinal axis. The detail portion includes a first linear rib and a second linear rib spaced from each other and extending along a periphery of the plurality of ribs between the first end and the second end of the detail portion. The detail portion includes a tube positioned relative to the plurality of ribs and extending through at least the detail portion along the longitudinal axis, wherein the tube is configured to deliver a fluid to the detail portion.

In addition to one or more of the features described above, or as an alternative, in further embodiments the detail cleaning device includes that the plurality of ribs are a plurality of elliptical ribs, the plurality of elliptical ribs having two vertexes on opposite sides and two co-vertexes on opposite ends, wherein the first linear rib and the second linear rib are transverse linear ribs that extend relative to the plurality of elliptical ribs along the two co-vertexes, and the detail portion further comprises a first serpentine rib and a second serpentine rib, the first and second serpentine ribs are transverse serpentine ribs that extend relative to the plurality of elliptical ribs along the two co-vertexes.

In addition to one or more of the features described above, or as an alternative, in further embodiments the detail cleaning device includes that the first serpentine rib and the second serpentine rib have a shape with a combination of alternating concave and convex portions, the first serpentine rib and the second serpentine rib being mirror images of each other.

In addition to one or more of the features described above, or as an alternative, in further embodiments the detail cleaning device includes that the plurality of elliptical ribs, the first linear rib and the second linear rib, and the first serpentine rib and the second serpentine rib are flexible.

In addition to one or more of the features described above, or as an alternative, in further embodiments the detail cleaning device includes that the detail portion has a variable flexibility along the longitudinal axis, wherein the detail portion defines a first flexibility in proximity to the first end and a second flexibility in proximity to the second end.

In addition to one or more of the features described above, or as an alternative, in further embodiments the detail cleaning device includes that the tube further includes a plurality of holes positioned along the tube substantially equidistant from each other.

In addition to one or more of the features described above, or as an alternative, in further embodiments the detail cleaning device includes that the first serpentine rib and the second serpentine rib are adapted to be deformed to include a substantially concave shape away from a plurality of holes formed on the tube.

In addition to one or more of the features described above, or as an alternative, in further embodiments the detail cleaning device includes that the handle body further includes a cavity formed in a top and middle portion of the handle body and a first end including a recess having a threaded counter bore configured to couple to a water source, the cavity and the recess are in fluid communication with the tube.

In addition to one or more of the features described above, or as an alternative, in further embodiments the detail cleaning device includes a middle section having a substantially cylindrical shape with a progressively decreasing diameter, the middle section disposed between the handle assembly and the detail portion.

In addition to one or more of the features described above, or as an alternative, in further embodiments the detail cleaning device includes a cleaning brush configured to couple with the detail portion along the longitudinal axis of the detail portion.

In addition to one or more of the features described above, or as an alternative, in further embodiments the detail cleaning device includes a flow control regulator in fluid communication with the tube.

According to an embodiment, a detail cleaning device is provided. According to an embodiment, the detail cleaning device includes a handle assembly having a handle body and a first end including a recess having a threaded counter bore configured to couple to a water source. The detail cleaning device includes a detail portion coupled to the handle assembly, the handle assembly and the detail portion defining a longitudinal axis. The detail portion includes a plurality of elliptical ribs spaced from each other along the longitudinal axis between a first end of the detail portion in proximity to the handle assembly and a second end opposite from the first end, the plurality of elliptical ribs defining a frustoconical shape along the longitudinal axis. The detail portion includes a first linear rib and a second linear rib spaced from each other and extending along a periphery of the plurality of elliptical ribs between the first end and the second end of the detail portion. The detail portion includes a tube positioned relative to the plurality of elliptical ribs and extending through at least the detail portion along the longitudinal axis, wherein the tube is configured to deliver a fluid to the detail portion.

In addition to one or more of the features described above, or as an alternative, in further embodiments the detail cleaning device includes that the handle assembly further includes at least one gripping feature forming about a periphery of the handle body.

In addition to one or more of the features described above, or as an alternative, in further embodiments the detail cleaning device includes that the plurality of elliptical ribs define two vertexes on opposite sides and two co-vertexes on opposite ends, wherein the first linear rib and the second linear rib are transverse linear ribs that extend relative to the plurality of elliptical ribs along the two co-vertexes, and a first serpentine rib and a second serpentine rib, the first and second serpentine ribs are transverse serpentine ribs that extend relative to the plurality of elliptical ribs along the two co-vertexes.

In addition to one or more of the features described above, or as an alternative, in further embodiments the detail cleaning device includes that the first serpentine rib and the second serpentine rib define a shape with a combination of alternating concave and convex portions, the first serpentine rib and the second serpentine rib being mirror images of each other.

In addition to one or more of the features described above, or as an alternative, in further embodiments the detail cleaning device includes that the plurality of elliptical ribs, the first linear rib and the second linear rib of the detail portion define a variable flexibility along the longitudinal axis, wherein the detail portion defines a first flexibility in proximity to the first end and a second flexibility in proximity to the second end.

In addition to one or more of the features described above, or as an alternative, in further embodiments the detail cleaning device includes a flow control regulator in fluid communication with the tube.

In addition to one or more of the features described above, or as an alternative, in further embodiments the detail cleaning device includes that the tube includes a tapered body.

In addition to one or more of the features described above, or as an alternative, in further embodiments the detail cleaning device includes a middle section having a substantially cylindrical shape with a progressively decreasing diameter, the middle section disposed between the handle assembly and the detail portion.

In addition to one or more of the features described above, or as an alternative, in further embodiments the detail cleaning device includes that the handle body further includes a cavity formed in a top and middle portion of the handle body, the cavity and the recess are in fluid communication with the tube.

### BRIEF DESCRIPTION OF THE DRAWINGS

The following descriptions should not be considered limiting in any way. With reference to the accompanying drawings, like elements are numbered alike:

FIG. 1 is a top perspective view of a wheel detailing brush;

FIG. 2 is a bottom perspective view of the wheel detailing brush of FIG. 1 according to an embodiment;

FIG. 3 is a front view of the wheel detailing brush of FIG. 1 according to an embodiment;

FIG. 4 is a rear view of the wheel detailing brush of FIG. 1 according to an embodiment;

FIGS. 5A and 5B is a left and right side view of the wheel detailing brush of FIG. 1 according to an embodiment;

FIGS. 6A and 6B is a side and bottom view of a cover or cloth for the wheel detailing brush according to an embodiment;

FIG. 7 is a top view of the wheel detailing brush of FIG. 1 according to an embodiment;

FIG. 8 is a cross-sectional view of the wheel detailing brush of FIG. 1 according to an embodiment;

FIG. 9 is a bottom view of the wheel detailing brush of FIG. 1 according to an embodiment;

FIG. 10 is a bottom perspective view of the wheel detailing brush of FIG. 1 according to an embodiment.

### DETAILED DESCRIPTION

A detailed description of one or more embodiments of the disclosed apparatus and method are presented herein by way of exemplification and not limitation with reference to the Figures.

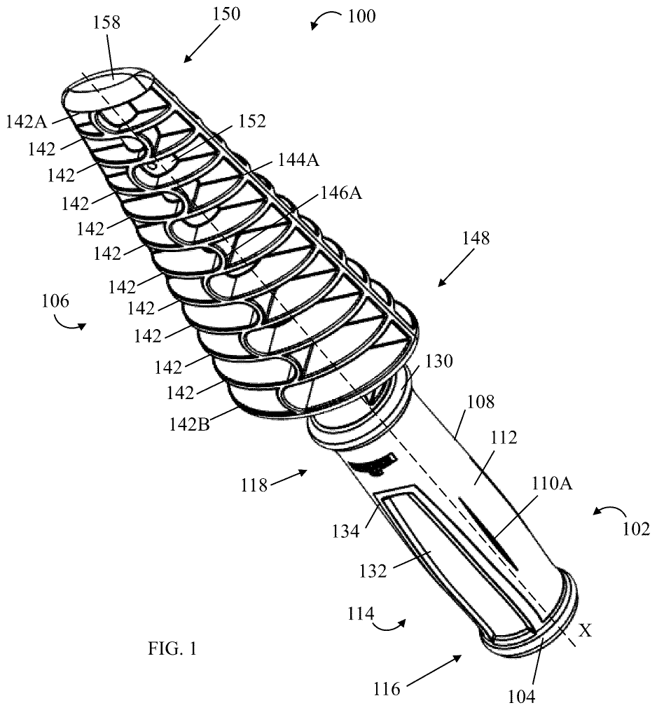

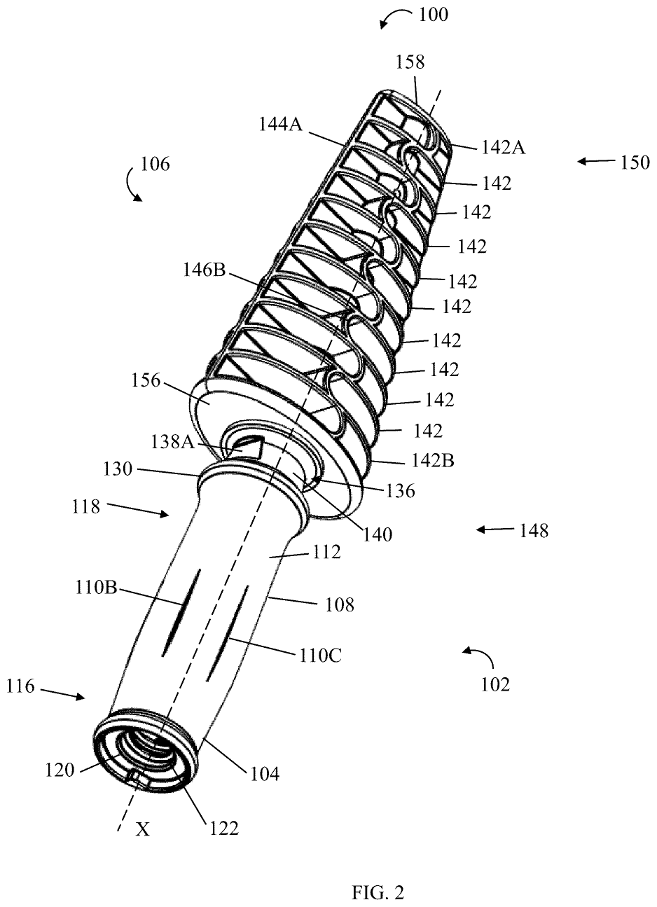

FIG. 1 is a top perspective view of a wheel detailing brush 100 and FIG. 2 is an bottom perspective view of the wheel detailing brush 100 of FIG. 1 according to an embodiment. The device 100 includes a handle assembly 102 coupled to a detail portion 106. The device 100 includes a handle assembly 102 having a handle body 104 and at least one gripping feature 108. The device 100 can be grasped by the handle body 104 and manipulated such that the detail portion 106 of the device 100 may be scrubbed against a vehicle wheel and inserted into small spaces and crevices of the vehicle wheel being cleaned. Additionally, the device 100 may be configured such that the handle body 104 can be secured to an extension pole/handle, a water-fed pole/handle, and/or a hose connected to a water-supply (not shown) in a manner such as, but not limited to, a threaded connection, a press-fit connection, or a locking connection.

The at least one gripping feature 108 may be mounted or co-molded to the handle body 104. The gripping feature 108 may be formed to an outer surface of the handle body 104 and wraps about the entire periphery of the handle body 104. The gripping feature 108 may be positioned and designed to facilitate a user's grasp about the handle body 104. For example, the gripping feature 108 may include at least one elongate slot 110A extending generally parallel to a longitudinal axis X of the device 100. In some embodiments, the gripping feature 108 may include a plurality of elongate slots 110A, 110B, 110C, 110D, 110E. In the illustrated, non-limiting embodiment, a plurality of elongate slots 110A-110E are spaced substantially equidistant about a periphery of the handle body 104. A surface 112 of the gripping feature 108 in between the plurality of elongate slots 110 may be a substantially smooth surface. In some embodiments, the surface 112 of the gripping feature 108 in between the plurality of elongate slots 110 may be a textured surface, for example a series of bumps or ridges. The textured surface may provide improved graspability of the handle body 104 be increasing the friction points between the user's hand and the gripping feature 108.

In some embodiments, the entire surface 112 of the gripping feature 108 may include a substantially smooth surface. Alternatively, the entire surface 112 of the gripping feature 108 may include the textured surface. In some embodiments, the gripping feature 108 may include at least one groove (not pictured) arranged within a plane substantially perpendicular to the longitudinal axis X, such that the groove wraps about at least a portion of the gripping feature 108, and in some embodiments an entirety, of the periphery of the gripping feature 108. It should be appreciated that the gripping features illustrated and described herein are intended as an example only and that a gripping feature having any suitable configuration is within the scope of the disclosure. Furthermore, embodiments where the handle body does not include any gripping features are also within the scope of the disclosure.

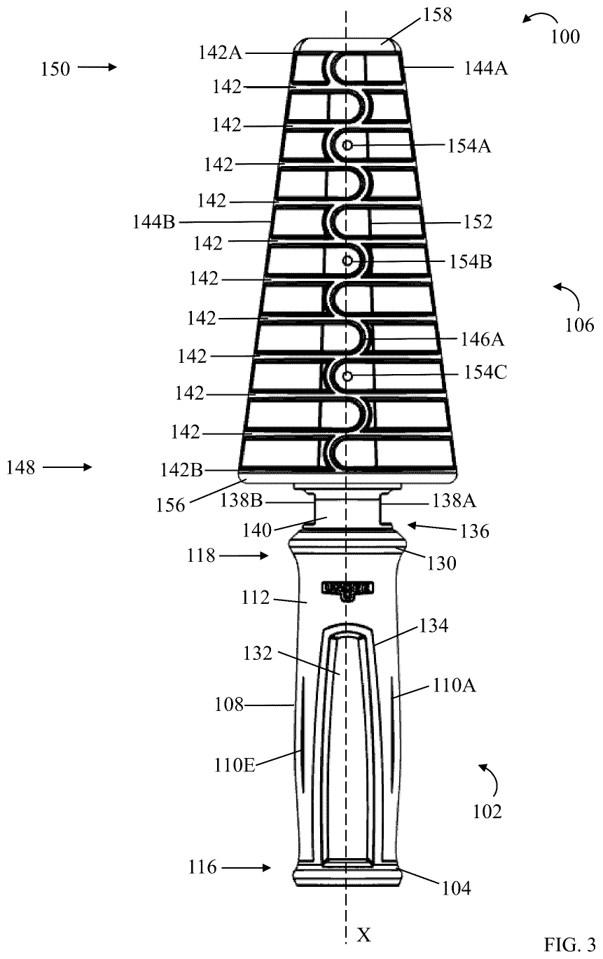

In some embodiments, the handle body 104 may include a recess, divot, or indent 132 on a front side 114 of the handle body 104 (FIG. 3). The gripping feature 108 may be formed to an outer surface of the handle body 104 and wraps about the entire periphery of the handle body 104 to a perimeter 134 of the indent 132. The indent 132 may be rectangular shaped, substantially rectangular shaped, oval shaped, substantially oval shape, ovoid shaped, substantially ovoid shaped, rounded triangular shaped, or substantially rounded triangular shaped. The indent 132 may extend from a first end 116 of the handle body 104 and extend lengthwise up the handle body 104 in a longitudinal direction, parallel to the longitudinal axis X. In some embodiments, the indent 132 may extend along one third the length of the handle body 104. In some embodiments, the indent 132 may extend one half up the length of the handle body 104. In yet other embodiments, the indent 132 may extend two thirds up the length of the handle body 104. The indent 132 may be sized to house the full or substantially the full width of the user's thumb. The indent 132 may enable the user to maintain a stronger hold on the device. The indent 132 creates an ergonomic shape in the handle body 104 and acts as an anchor point for a user's phalange, for example the thumb, providing a more stable grip on the handle body 104.

A detail portion 106 extends from a second end 118 of the handle body 104 with a middle section 136 disposed therebetween. The middle section 136 may have a diameter less than a diameter of the handle body 104. The middle section 136 may be substantially cylindrical in shape with a consistent diameter. In some embodiments, the middle section 136 may be substantially cylindrical with a tapered shape such that a diameter near the second end 118 of the handle body 104 is greater than a diameter near a bottom end 148 of the detail portion 106, such that the diameter of the middle section 136 progressively decreases in size from an end coupled to the second end 118 of the handle body 104 to an end coupled to the bottom end 148 of the detail portion 106. In some embodiments, the middle section 136 is hollow. In some embodiments, the middle section 136 may include at least one void 138A formed on a surface 140 of the middle section 136. In some embodiments, the middle section 136 includes a first void 138A and a second void 138B. The first void 138A and the second void 138B are located on opposite sides of the middle section 136. The first void 138A and the second void 138B are diametrically opposed.

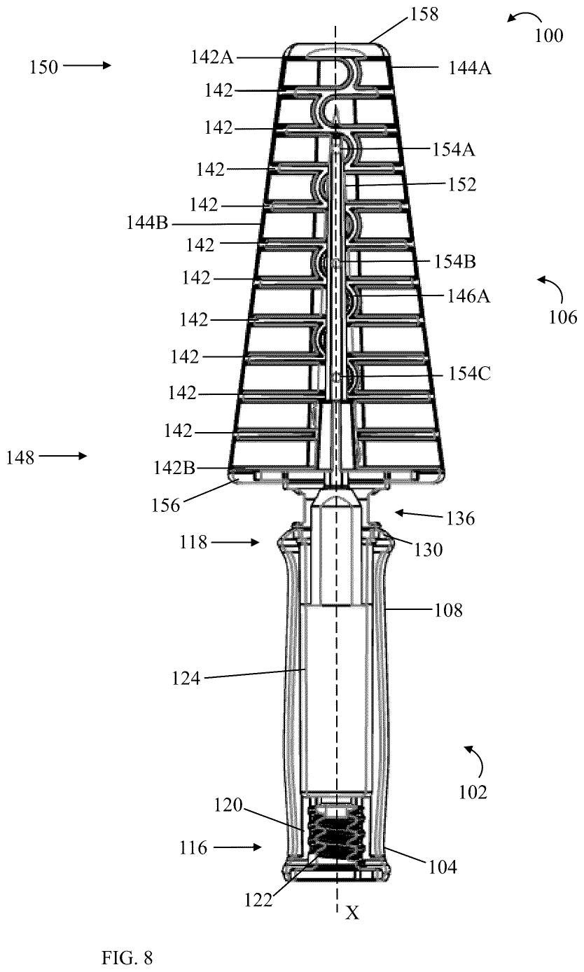

The detail portion 106 is frustoconical in shape, including a plurality of ribs 142 with a tube 152 positioned relative thereto. The plurality of ribs are spaced from each other along the longitudinal axis X of the detail portion 106. The tube extends along the longitudinal axis X relative to the plurality of ribs 142. In some instances, the tube 152 may substantially transect the center of the plurality of ribs 142 along the longitudinal axis X (FIG. 8). The tube 152 may be hollow and in fluid communication with the middle section 136. The detail portion 106 may be sized and shaped to promote flexibility to enable ease of use in, for example, tight locations of a wheel. The detail portion 106 may be more flexible in one direction and less flexible in the other, an embodiment of which is described in more detail below.

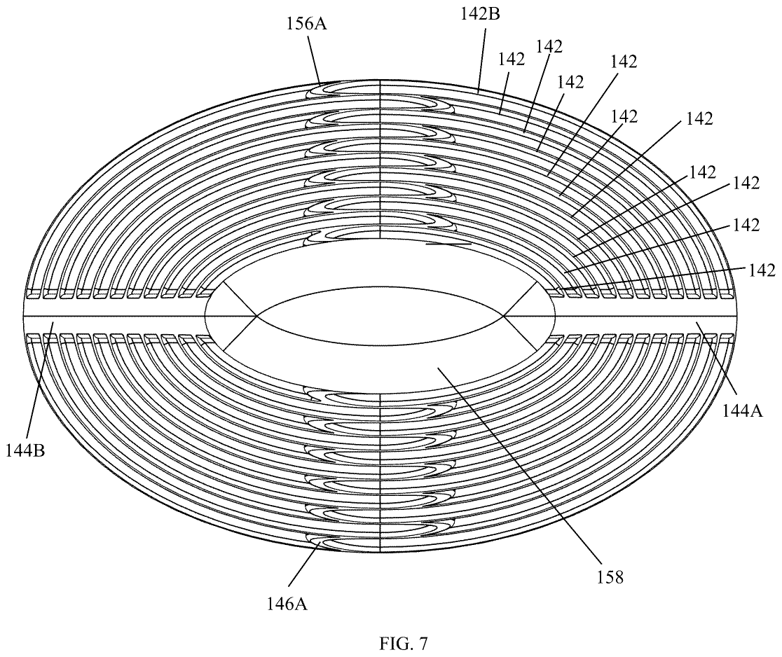

In an embodiment, the detail portion 106 is frustoconical in shape and includes a plurality of elliptical ribs 142. Although depicted as elliptical ribs 142 (e.g., FIG. 7), it should be understood that the ribs 142 may be variously-shaped, such as, but not limited to, quadrilateral (e.g., square, diamond, rectangle), triangular, circular, and combinations thereof. Thus, the detail portion 106 may be frustoconical in shape with a plurality of ribs 142 defining one or more shapes. It should be understood that instances where an elliptical rib 142 is described may be replaced with another shape, without departing from the spirit/scope of this disclosure.

In an embodiment, the detail portion 106 may be about 10 inches in length. In some embodiments, the detail portion 106 may be about 5-10 inches inclusive, in length. In some embodiments, the detail portion 106 may be about 10-12 inches, inclusive, in length. The plurality of elliptical ribs 142 may be formed using a material such as, but not limited, to a thermoplastic elastomer (TPE). The TPE material allows the detail portion 106 to flex and bend such that it can be inserted into crevices and other small areas of wheels. The plurality of elliptical ribs 142 include two axes of symmetry, the longer axis being the major axis and the shorter axis being the minor axis. Each endpoint of the major axis is the vertex of the plurality of elliptical ribs 142, and each endpoint of the minor axis is a co-vertex of the plurality of elliptical ribs 142. The plurality of elliptical ribs 142 includes two vertexes on opposite endpoints and two co-vertexes on opposite endpoints, the vertex endpoints and the co-vertex endpoints being different endpoints.

The detail portion 106 defines the bottom end 148 and a top end 150 opposite from the bottom end 148 along a longitudinal axis X. The detail portion 106 may include at least one linear rib 144. The at least one linear rib 144 may be a transverse linear rib 144 that extends relative to a periphery of the plurality of ribs 142. The at least one linear rib 144 extends at least between the bottom end 148 and the top end 150 of the detail portion 106. In some embodiments, the detail portion 106 includes a first linear rib 144A and a second linear rib 144B that are spaced from each other. The first and second linear ribs 144A, 144B are transverse linear ribs 144A, 144B that extend relative to a periphery of the plurality of ribs 142. The detail portion 106 may further include the at least one linear rib 144A extending along an edge of the plurality of elliptical ribs 142 at the vertex. The first linear rib 144A and the second linear rib 144B extend at least between the bottom end 148 and the top end 150 of the detail portion 106 such that the plurality of elliptical ribs 142 intersect with the first linear rib 144A and the second linear rib 144B. The at least one linear rib 144A may be in line, i.e. located on the side, with the first void 138A or the second void 138B of the middle section 136. In some embodiments, the detail portion 106 includes a first linear rib 144A and a second linear rib 144B. The first linear rib 144A and the second linear rib 144B are located on opposite vertexes of the plurality of elliptical ribs 142. The first linear rib 144A and the second linear rib 144B are diametrically opposed. The first linear rib 144A is in line, i.e. located on the side, with the first void 138A and the second linear rib 144B is in line, i.e. located on the side, with the second void 138B.

The detail portion 106 may further include at least one serpentine rib 146A. The at least one serpentine rib 146A is a transverse serpentine rib 146A that extends relative to an edge of the plurality of elliptical ribs 142 at the co-vertex. The at least one serpentine rib 146A has a shape with a combination of alternating concave and convex portions. In some embodiments, the detail portion 106 includes a first serpentine rib 146A and a second serpentine rib 146B. The first serpentine rib 146A and the second serpentine rib 146B are located on opposite co-vertexes of the plurality of elliptical ribs 142 and are similar to (or mirror images of) each other. The serpentine ribs 146A, 146B may be spring-like elements configured to have some degree of flexibility. In a non-limiting example, the serpentine ribs 146A, 146B may define a C-shaped configuration.

The plurality of elliptical ribs 142 allow the detail portion 106 to flex and bend into small spaces and crevices in the wheel to clean the crevices. The linear rib 144 and the serpentine rib 146 are positioned to support the plurality of elliptical ribs 142. In some instances, the linear rib 144 and/or the serpentine rib 146 may provide rigidity to the detail portion 106 such that a user does not apply excessive force to clean the wheel, while still being flexible. In some embodiments, the plurality of elliptical ribs 142 may have greater flexibility than the first serpentine rib 146A and second serpentine rib 146B, and the first linear rib 144A and second linear rib 144B. In some embodiments, the plurality of elliptical ribs 142 may have the same flexibility as the first serpentine rib 146A and second serpentine rib 146B, and the first linear rib 144A and second linear rib 144B.

In some instances, the flexibility of the detail portion 106 may be variable in at least one direction. For example, a portion of the detail portion 106 in proximity to the bottom end 148 may define a first flexibility and a portion of the detail portion 106 in proximity to the top end 150 opposite from the bottom end 148 along the longitudinal axis X may define a second flexibility. The first flexibility may be less flexible than the second flexibility. Thus, the portion of the detail portion 106 in proximity to the top end 150 may have increased flexibility versus the portion of the detail portion 106 in proximity to the bottom end 148.

In some instances, the detail portion 106 may have increased flexibility in one direction versus another direction along the longitudinal axis X. For example, the detail portion 106 may have increased flexibility in a direction perpendicular to a plan defined by the linear ribs 144 versus the direction planar to the linear ribs 144. Thus, the linear ribs 144 may provide support to reduce the flexibility of the detail portion 106 in at least one direction.

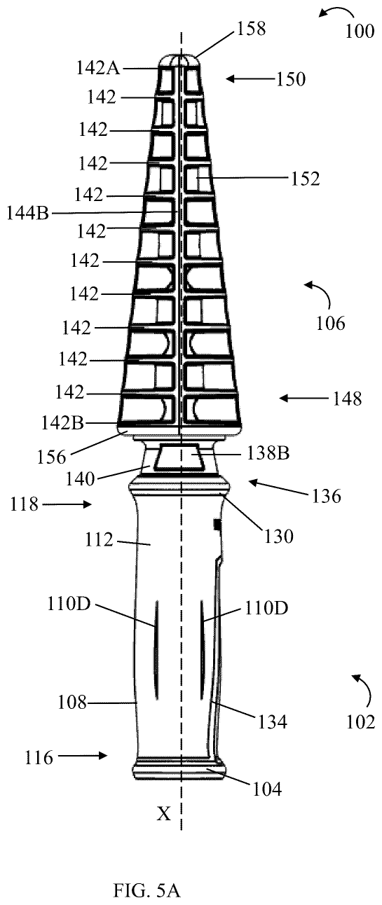

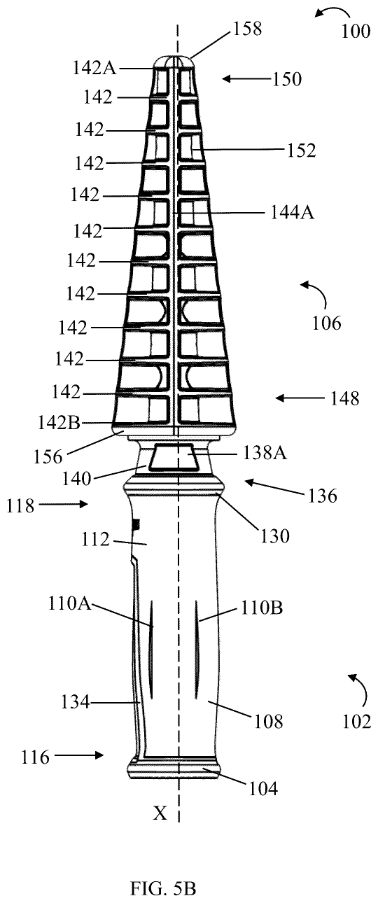

Referring now to FIGS. 3-5B, various views are shown of the wheel detailing brush. The co-vertexes of the plurality of elliptical ribs 142 are located along the longitudinal axis X. The first serpentine rib 146A and the second serpentine rib 146B traverses opposite co-vertexes of the plurality of elliptical ribs along the longitudinal axis X. The plurality of elliptical ribs 142 may consist of 3-5 elliptical ribs, 5-7 elliptical ribs, 7-9 elliptical ribs, or 9-12 elliptical ribs, inclusive. Those skilled in the art will appreciate that any number of elliptical ribs 142 may be employed without departing from the scope of the present disclosure.

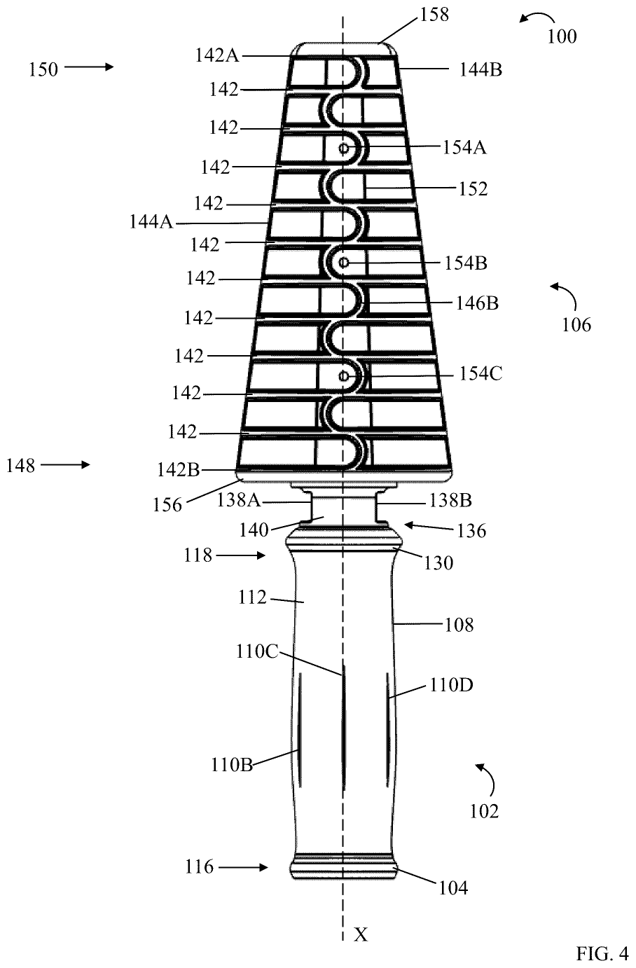

As shown in FIGS. 3 and 4, the tube 152 may include a plurality of holes 154A, 154B, 154C. In an embodiment, the plurality of holes 154A-C extends through the tube 152 such that the plurality of holes 154A-C comprise of two openings diametrically opposed on the tube 152. The plurality of holes 154A-C may be spaced substantially equidistant from each other. Although shown in this embodiment with three holes 154A-C, those of skill in the art will appreciate that any number of holes may be employed without departing from the scope of the present disclosure. For example, in some embodiments, a single hole may be positioned substantially centered on the tube 152. In other embodiments, two, four, or more holes may be used. The first serpentine rib 146A and the second serpentine rib 146B may bend around the plurality of holes 154A-C such that the first serpentine rib 146A and the second serpentine rib 146B include sections deformed to have a substantially concave shape away from the respective hole.

In some embodiments, the detail portion 106 includes a bottom cap 156 and a top cap 158. The top cap 158 and the bottom cap 156 may have the same or substantially the shape as the elliptical ribs. The bottom cap 156 encloses the bottom end 148 of the detail portion 106 and the top cap 158 encloses the top end 150 of the detail portion 106. The top cap 158 may have the same diameter as the top-most elliptical rib 142A. In some embodiments, the top cap 158 may have a greater diameter or a smaller diameter than the diameter of the top-most elliptical rib 142A. The bottom cap 156 may have the same diameter at the bottom-most elliptical rib 142B. In some embodiments, the bottom cap 156 may have a greater diameter or a smaller diameter than the diameter of the bottom-most elliptical rib 142B. The top cap 158 and the bottom cap 156 may provide additional rigidity to the detail portion 106 such that a user may effectively clean a wheel without having to apply excessive force. The handle body 104 may further include a lip 130 at the second end 118. The lip 130 acts as a stopper to prevent the user's hand from sliding off the handle body 104 and butting against the detail portion 106 during use.

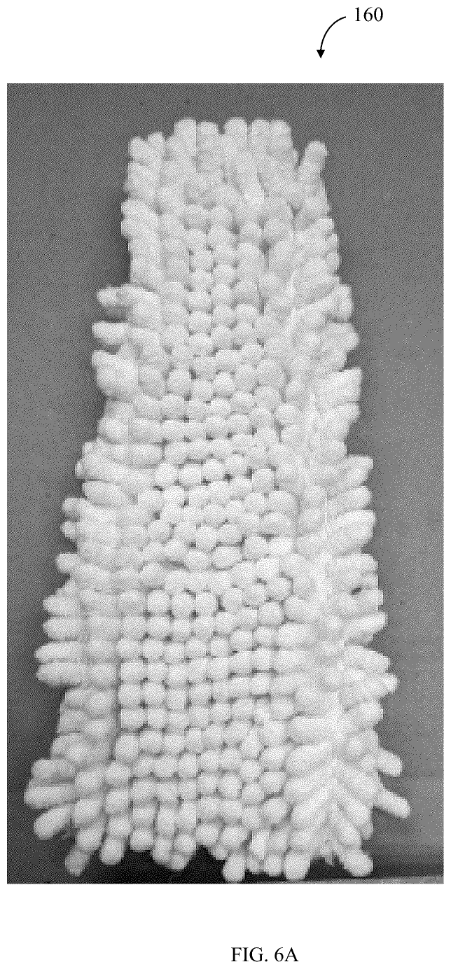

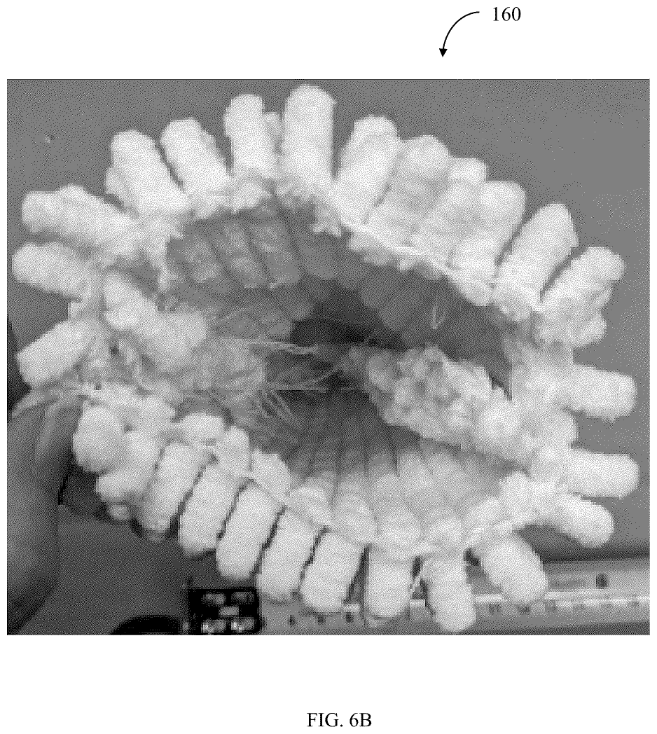

The device 100 may further include a removable cleaning brush 160 or cloth/sleeve as shown in FIGS. 6A and 6B. The removable cleaning brush 160 may have a hollow interior such that it may slide over at least a portion of the detail portion 106 and conform to at least a portion of the detail portion 106. The cleaning brush 160 may be shaped to have substantially the same shape as the detail portion 106. In some embodiments, the cleaning brush 160 may include a textured surface, for example a surface that includes a series of bumps/ridges. The cleaning brush 160 may be secured to at least a portion of the detail portion 106 via hook and loop fastener, a press-fit connection, a friction fit, or combinations thereof. In use, a fluid (e.g., water) saturates the cleaning brush 160 as it flows through at least a portion of the device 100. For example, water saturates the cleaning brush 160 as it flows through a recess 120, a cavity 124, the middle section 136, and the tube 152 out of a plurality of holes 154 of the device 100, as described below.

As shown in FIG. 7, in an embodiment the plurality of elliptical ribs 142 are configured to stack over each other (when viewed axially) and may progressively decrease in size from the bottom end 148 of the detail portion 106 to the top end 150 of the detail portion 106. In some embodiments, the bottom-most elliptical rib 142B has the largest diameter of the plurality of elliptical ribs 142 and the top-most elliptical rib 142A has the smallest diameter of the plurality of elliptical ribs 142, with the elliptical ribs disposed therebetween having progressively decreasing diameters. In some embodiments, the bottom-most elliptical rib 142B may have a diameter of about 4 inches. In some embodiments, the bottom-most elliptical rib 142B may have a diameter of about 1-4 inches, inclusive. In yet other embodiments, the bottom-most elliptical rib 142B may have a diameter of about 4-6 inches, inclusive. Accordingly, the detail portion 106 may have a bottom diameter of about 4 inches, 1-4 inches, or 4-6 inches.

Referring now to FIG. 8, an embodiment is shown of a cross-sectional view of the wheel detailing brush 100 of FIG. 1. The first end 116 of the handle body 104 may define a recess 120 having a threaded counter bore 122 to secure the device 100 to a water source, such as, but not limited to, a water device, a water-fed pole, or a water hose (connected to a water-source, not shown). In some embodiments, the threaded counter bore 122 may be used for a water-fed pole or water-fed hose, which provides a fluid, such as, but not limited to, water, a cleaning solution, or water and a cleaning solution, directly into or at the detail portion 106. Running water may be fed from a water-fed pole or water-fed hose to the device 100 to clean vehicle wheels. In this way, the device 100 can used to clean vehicle wheels, while water is supplied to the device 100, thereby reducing (or removing) the need to consistently dip the cleaning tool into a bucket or other external source of water to rinse off the dirt and replenish the tool with water/cleaning solution.

The handle body 104 may further include a hollow interior defining a cavity 124 formed in a top portion 126 and a middle portion 128 of the handle body 104, extending toward the recess 120. The recess 120 and cavity 124 may be in fluid communication such that when a water source is coupled to the threaded counter bore 122, water may flow into the cavity 124. The cavity 124 may have substantially the same shape as the handle body 104. Additionally, the cavity 124 may be in fluid communication with the middle section 136 and tube 152. Accordingly, the recess 120 and cavity 124 place the detail portion 106 in fluid communication with a water source.

As described above, the tube 152 transects substantially the center of the plurality of elliptical ribs 142 along the longitudinal axis X. The tube 152 may have the same length as the detail portion 106. In some embodiments, the tube 152 may have length that is shorter than the length of the detail portion 106, such as but not limited to, a length that is two-thirds of the length of the detail portion 106, half of the length of the detail portion 106, or one-third of the length of the detail portion 106. In an embodiment, the tube 152 includes a plurality of holes 154A-C spaced substantially equidistant from each other. The plurality of holes 154A-C allow for the water and/or cleaning solution to be evenly or substantially evenly disbursed along the detail portion 106. As such, water may be fed from a water source, for example a water-fed pole or hose directly to the plurality of elliptical ribs 142 of the detail portion 106. As water is supplied from a water source, it travels through the recess 120, the cavity 124, and the tube 152 and exits the tube 152 through the plurality of holes 154a-c, providing liquid to the plurality of elliptical ribs 142 of the detail portion 106.

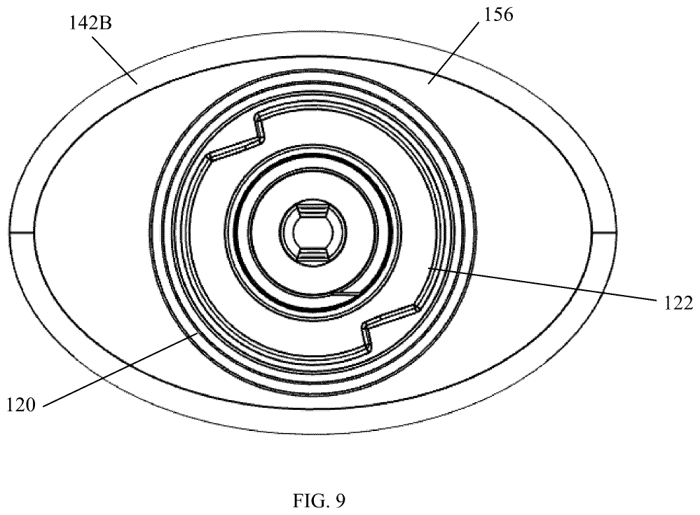

FIG. 9 is a bottom view of the wheel detailing brush of FIG. 1 according to an embodiment. In some embodiments, the bottom cap 156 may have a diameter dimensioned smaller than the diameter of the bottom-most elliptical rib 142B, as illustrated in FIG. 9. The handle body 104 may have a substantially cylindrical shape and a diameter that is dimensioned smaller than the distance between the co-vertexes of the plurality of elliptical ribs 142.

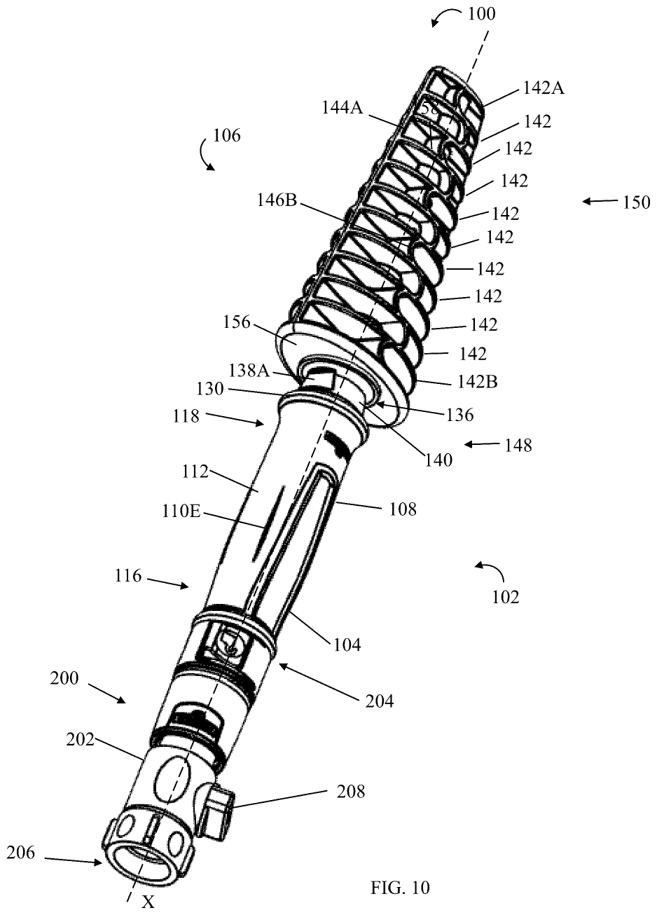

FIG. 10 is a perspective view of the vehicle detailing brush of FIG. 1 according to an embodiment. In some embodiments, the device 100 includes a flow control regulator mounted in fluid communication with the first end 116 of the handle body 104. The flow control regulator 200 includes a body 202 defined by a first end 204 and a second end 206 opposite from the first end 204. The first end 204 of the body 202 may be removably coupled to the handle body 104. For example, the first end 204 of the body 202 may be removably coupled to the threaded counter bore 122 of the handle body 104. The flow control regulator 200 may be configured to provide automatic, semi-automatic, or manual regulation of the water and/or cleaning solution delivery to the detail portion 106. In some instances, the flow control regulator 200 may include a dial 208 configured to adjust the flow of the water and/or cleaning solution. Adjustment of the flow of the water and/or cleaning solution may include reducing, increasing, or stopping the flow. Instances where the flow control regulator 200 is configured to automatically or semi-automatically adjust the flow of the water and/or the cleaning solution, the dial 208 may also be used to adjust the flow.

In an embodiment, the first end 204 and the handle body 104 may be configured to couple using the locking system described in commonly owned U.S. Pat. No. 8,745,837B2 entitled “Locking system for connecting poles and tools”, the contents of which are incorporated herein by reference.

It should be appreciated that while embodiments herein refer to the tool or device 100 as being used with a vehicle wheel, this is for exemplary purposes and the claims should not be so limited. In other embodiments, the tool may be used to clean other types of objects, such as but not limited to engine components, wheel wells, bumpers, automobile grills, propeller and propeller shafts, and the like.

As used herein, the term “elliptical” refers to the cross-sectional shape of the rib 142, resembling an ellipse, between the first linear rib 144A and the second linear rib 144B. The elliptical shape defines a major axis between the first linear rib 144A and the second linear rib 144B and a minor axis that is perpendicular to the major axis, where the major axis is greater than the minor axis.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A detail cleaning device comprising:
a handle assembly comprising a handle body;
a detail portion coupled to the handle assembly, the handle assembly and the detail portion defining a longitudinal axis, the detail portion comprising:
a plurality of ribs spaced from each other along the longitudinal axis between a first end of the detail portion in proximity to the handle assembly and a second end opposite from the first end, the plurality of ribs defining a frustoconical shape along the longitudinal axis, and
a first linear rib and a second linear rib spaced from each other and extending along a periphery of the plurality of ribs between the first end and the second end of the detail portion; and
a tube positioned relative to the plurality of ribs and extending through at least the detail portion along the longitudinal axis, wherein the tube is configured to deliver a fluid to the detail portion.

2. The detail cleaning device of claim 1, wherein the plurality of ribs are a plurality of elliptical ribs, the plurality of elliptical ribs having two vertexes on opposite sides and two co-vertexes on opposite ends, wherein the first linear rib and the second linear rib are transverse linear ribs that extend relative to the plurality of elliptical ribs along the two co-vertexes, and the detail portion further comprises a first serpentine rib and a second serpentine rib, the first and second serpentine ribs are transverse serpentine ribs that extend relative to the plurality of elliptical ribs along the two co-vertexes.

3. The detail cleaning device of claim 2, wherein the first serpentine rib and the second serpentine rib have a shape with a combination of alternating concave and convex portions, the first serpentine rib and the second serpentine rib being mirror images of each other.

4. The detail cleaning device of claim 2, wherein the plurality of elliptical ribs, the first linear rib and the second linear rib, and the first serpentine rib and the second serpentine rib are flexible.

5. The detail cleaning device of claim 1, wherein the detail portion has a variable flexibility along the longitudinal axis, wherein the detail portion defines a first flexibility in proximity to the first end and a second flexibility in proximity to the second end.

6. The detail cleaning device of claim 1, wherein the tube further comprises a plurality of holes positioned along the tube substantially equidistant from each other.

7. The detail cleaning device of claim 3, wherein the first serpentine rib and the second serpentine rib are adapted to be deformed to include a substantially concave shape away from a plurality of holes formed on the tube.

8. The detail cleaning device of claim 7, wherein the handle body further comprises a cavity formed in a top and middle portion of the handle body and a first end including a recess having a threaded counter bore configured to couple to a water source, the cavity and the recess are in fluid communication with the tube.

9. The detail cleaning device of claim 1, further comprising a middle section having a substantially cylindrical shape with a progressively decreasing diameter, the middle section disposed between the handle assembly and the detail portion.

10. The detail cleaning device of claim 1, further comprising a cleaning brush configured to couple with the detail portion along the longitudinal axis of the detail portion.

11. The detail cleaning device of claim 1, further comprising a flow control regulator in fluid communication with the tube.

12. A detail cleaning device comprising:
a handle assembly having a handle body and a first end including a recess having a threaded counter bore configured to couple to a water source;
a detail portion coupled to the handle assembly, the handle assembly and the detail portion defining a longitudinal axis, the detail portion comprising:
a plurality of elliptical ribs spaced from each other along the longitudinal axis between a first end of the detail portion in proximity to the handle assembly and a second end opposite from the first end, the plurality of elliptical ribs defining a frustoconical shape along the longitudinal axis, and
a first linear rib and a second linear rib spaced from each other and extending along a periphery of the plurality of elliptical ribs between the first end and the second end of the detail portion; and
a tube positioned relative to the plurality of elliptical ribs and extending through at least the detail portion along the longitudinal axis, wherein the tube is configured to deliver a fluid to the detail portion.

13. The detail cleaning device of claim 12, wherein the handle assembly further comprises at least one gripping feature forming about a periphery of the handle body.

14. The detail cleaning device of claim 12, wherein the plurality of elliptical ribs define two vertexes on opposite sides and two co-vertexes on opposite ends, wherein the first linear rib and the second linear rib are transverse linear ribs that extend relative to the plurality of elliptical ribs along the two co-vertexes, and a first serpentine rib and a second serpentine rib, the first and second serpentine ribs are transverse serpentine ribs that extend relative to the plurality of elliptical ribs along the two co-vertexes.

15. The detail cleaning device of claim 14, wherein the first serpentine rib and the second serpentine rib define a shape with a combination of alternating concave and convex portions, the first serpentine rib and the second serpentine rib being mirror images of each other.

16. The detail cleaning device of claim 12, wherein the plurality of elliptical ribs, the first linear rib and the second linear rib of the detail portion define a variable flexibility along the longitudinal axis, wherein the detail portion defines a first flexibility in proximity to the first end and a second flexibility in proximity to the second end.

17. The detail cleaning device of claim 12, further comprising a flow control regulator in fluid communication with the tube.

18. The detail cleaning device of claim 12, wherein the tube includes a tapered body.

19. The detail cleaning device of claim 12, further comprising a middle section having a substantially cylindrical shape with a progressively decreasing diameter, the middle section disposed between the handle assembly and the detail portion.

20. The detail cleaning device of claim 19, wherein the handle body further comprises a cavity formed in a top and middle portion of the handle body, the cavity and the recess are in fluid communication with the tube.
